(19) United States
(12) Patent Application Publication
(10) Pub. No.: US 2009/0322711 A1
(43) Pub. Date: Dec. 31, 2009

(54) LCD CONTROLLER CHIP

(75) Inventors: THOMAS S. DAVID, Austin, TX (US); BRIAN CALOWAY, Georgetown, TX (US); GOLAM CHOWDHURY, AUSTIN, TX (US); BRENT WILSON, Austin, TX (US); FARRIS BAR, Pflugerville, TX (US); DOUGLAS PIASECKI, AUSTIN, TX (US)

Correspondence Address: HOWISON & ARNOTT, L.L.P, P.O. BOX 741715, DALLAS, TX, 75374-1715, US

(73) Assignee: SILICON LABORATORIES INC., AUSTIN, TX (US)

(21) Appl. No.: 12/146,349

(22) Filed: Jun. 25, 2008

(51) Int. Cl. G06F 3/01; G09G 5/00; G09G 3/36

(52) U.S. Cl. 345/204; 345/104

(57) ABSTRACT

An integrated circuit comprises a host interface control block for providing a connection between the integrated circuit and a master controller device. The integrated circuit further includes a plurality of I/O pins. A capacitive touch sense circuitry enables detection of actuation of at least one capacitor switch of a capacitive sensor array connected to at least a portion of the plurality of I/O pins. An LCD controller drives at least one LCD connected to at least a portion of the plurality of I/O pins. The integrated circuit, responsive to signals received from the master controller device over the host interface control block, may be configured to monitor outputs from the capacitive sensor array in a first mode of operation. In a second mode of operation, the capacitive sensor array may be configured to drive at least one LCD. Finally, in a third mode of operation, the integrated circuit may be configured to both monitor outputs of the capacitive sensor array and drive the at least one LCD.

### CROSS-REFERENCE TO RELATED APPLICATIONS

N/A

### TECHNICAL FIELD

The present invention relates to LCD controllers, and more particularly, to LCD controllers having the ability to drive both LCD displays and to detect capacitive switches within connected capacitive sensor arrays.

### BACKGROUND

Electronic circuit design often requires the use of various interface circuitries such as liquid crystal displays (LCDs) and capacitive sensor arrays that enable the user to interact with or receive information from an electronic circuit. Typically, LCD displays are driven by dedicated LCD driver controllers which enable a circuit to control an LCD display to display desired information on the segments of the LCD display. Similarly, dedicated sensing circuitry may be used to detect the activation of various capacitive switches within a capacitive sensor array enabling a user to input particular information into a circuit.

An additional requirement of many capacitive switch sensing circuitries is the ability to connect to each of the capacitive switches within an array and this, of course, requires a large number of I/O pins to be associated with the capacitive sensing circuitries. The requirement for a large number of I/O pins to be dedicated with each capacitive switch and the requirement for dedicated capacitive sensing circuitry and LCD driver controller circuitry, for devices having these requirements, can result in an increase in chip size in order to include all of these components. Therefore, there is a need for circuit designers to have the ability to more conveniently implement capacitive sensor arrays and LCD drivers within circuit designs that do not require the complexities and space limitations associated with existing dedicated circuitries.

### SUMMARY

The present invention, as disclosed and described herein comprises, in one aspect thereof, an integrated circuit. The integrated circuit includes a host interface control block for providing a connection between the integrated circuit and a master controller device. The integrated circuit additionally includes a plurality of I/O pins. A capacitive touch sense circuitry enables detection of actuation of at least one capacitive switch of a capacitive sensor array connected to at least a portion of the plurality of I/O pins. An LCD controller drives at least one LCD connected to at least a portion of a plurality of I/O pins. The integrated circuit operates such that, responsive to control signals received from the master controller device over the host interface control block the integrated circuit will be configured to operate in a first mode of operation wherein it monitors outputs from the capacitive sensor array; to operate in a second a mode of operation wherein it drives the at least one LCD; and to operate in a third mode of operation wherein it both monitors outputs of the capacitive sensor array and drives the at least one LCD; and to operate in a fourth mode of operation wherein it monitors outputs of the capacitive sensing array, drives the at least one LCD and monitors or drives at least one GPIO pin.

### BRIEF DESCRIPTION OF THE DRAWINGS

For a more complete understanding, reference is now made to the following description taken in conjunction with the accompanying Drawings in which:

FIG. 1 is a functional block diagram illustrating the LCD controller slaved to a controller chip and controlling multiple liquid crystal displays;

FIG. 2 is a block diagram of the LCD controller chip;

FIGS. 3a-b are flow diagrams illustrating the operation of the capacitive touch sensor block of the LCD controller;

FIG. 4 illustrates an interconnection between the LCD controller and a capacitive sensor array;

FIG. 5 is a functional block diagram of the capacitive touch sense circuitry;

FIG. 6 is a more detailed schematic diagram of the capacitive touch sense circuitry;

FIG. 7 is a flow diagram describing the operation of the state control engine of the successive approximation engine;

FIG. 8 illustrates an SFR register used for storing indications of detections of activation of an associated capacitive switch within a capacitive sensor array;

FIG. 9 is a functional block diagram of the LCD driver controller;

FIG. 10 illustrates the dual resistor ladders used with the charge pump circuitry of the LCD driver controller; and

FIG. 11 illustrates the various configurations of the LCD controller and master controller according to the present disclosure.

### DETAILED DESCRIPTION

Referring now to the drawings, wherein like reference numbers are used herein to designate like elements throughout, the various views and embodiments of an LCD controller chip are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

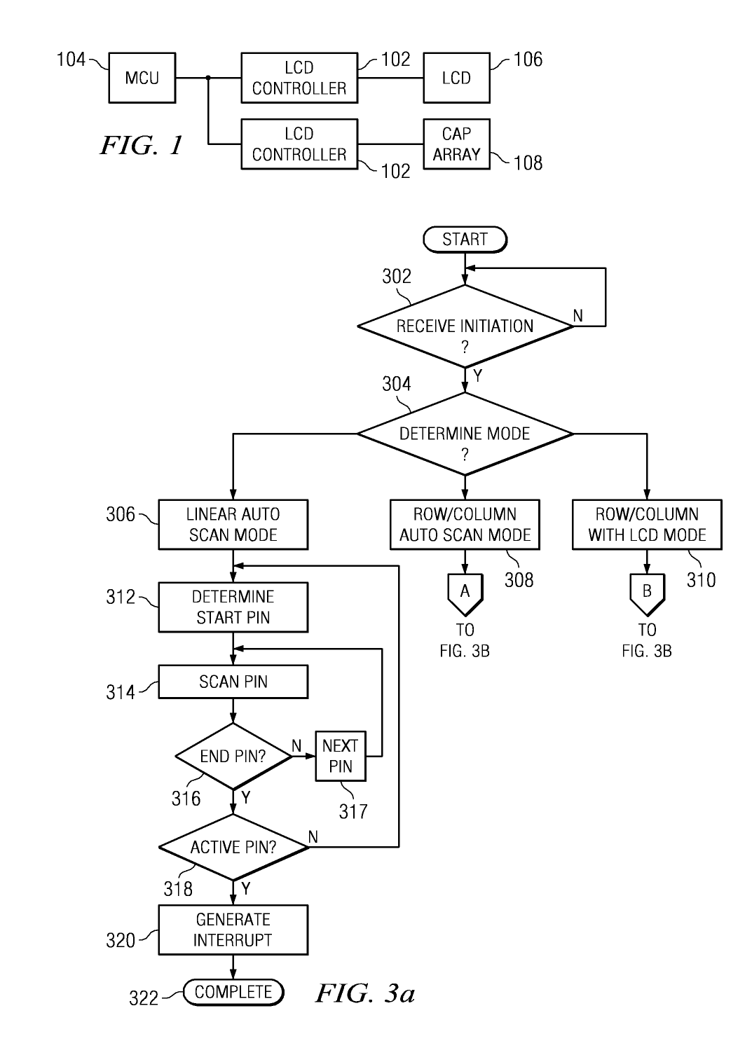

Referring now to the drawings, and more particularly to FIG. 1, there is illustrated a functional block diagram of a plurality of LCD controller chips 102 that are connected as slave devices to a controlling microcontroller unit 104. The microcontroller 104 can comprise any number of microcontroller units having master control capabilities. The LCD controllers 102 may interface with the microcontroller unit 104 via either a SPI interface, SMbus interface, or EMIF interface all in the slave mode. The LCD controllers 102 may be connected to an LCD display 106 or, alternatively, may be used with a capacitor switch array 108 using included capacitive sensor functionalities and LCD control functionalities that will be described herein below, or may be used as a GPIO expander.

As will be described herein below, the MCU 104 is operable to selectively control each of the LCD controllers 102. In general, each of the LCD controllers 102 is addressable via the interconnection therewith through a communication bus 110. This communication bus 110, as will be described herein below, can be a parallel communication bus or a serial communication bus. Each of the LCD controllers 102 is addressable such that data can be transferred to or from each LCD controller 102. These LCD controllers 102 can be enabled or disabled, placed into a low power mode, or into a full power mode. They can each be configured to operate in accordance with a predetermined port configuration information. For example, the LCD controller 102 having the LCD 106 associated therewith is configured as such, although both LCD controllers 102 are identical. Once configured, the LCD controller 102 has data transmitted thereto from the MCU 104 for storage therein which is then used to drive the LCD 106 in the appropriate manner. Generally, when information is sensed from the capacitor array 108 by the LCD controller in a scanning operation, as will be described herein below, an interrupt will be provided, which interrupt is passed back to the MCU 104 through the bus 110 (the bus 110 includes address, control and data information). Thus, the LCD controller 102 operates independent of the MCU 104 during the scanning operation of the capacitor array 108. Once the capacitor array 108 has sensed a touch or a depression of a button, the LCD controller 102 will receive an indication of such, i.e., a “hit,” and an interrupt will be generated. Once the interrupt is generated, the MCU 104 then accesses a register in the LCD controller 102 for the purpose of determining which area was touched on the capacitor array 108.

As will also be described herein below, each of the LCD controllers 102 can be placed into a low power mode where all the power is removed internally except for essential parts thereof. For example, the LCD controller 102 associated with the capacitor array 108 could be placed into a low power mode where the capacitor array was merely scanned. The remainder of the chip can be turned off until an interrupt is generated. Once the interrupt is generated, the LCD controller 102 will be powered back up, i.e., enabled, by the MCU 104 after it receives the interrupt. At this time, the LCD controller 102 will receive program instructions from the MCU 104 to reconfigure the LCD controller 102 in such a manner so as to clear all registers therein and reconfigure the device. This is done for the reason that the LCD controller 102 has no memory associated therewith.

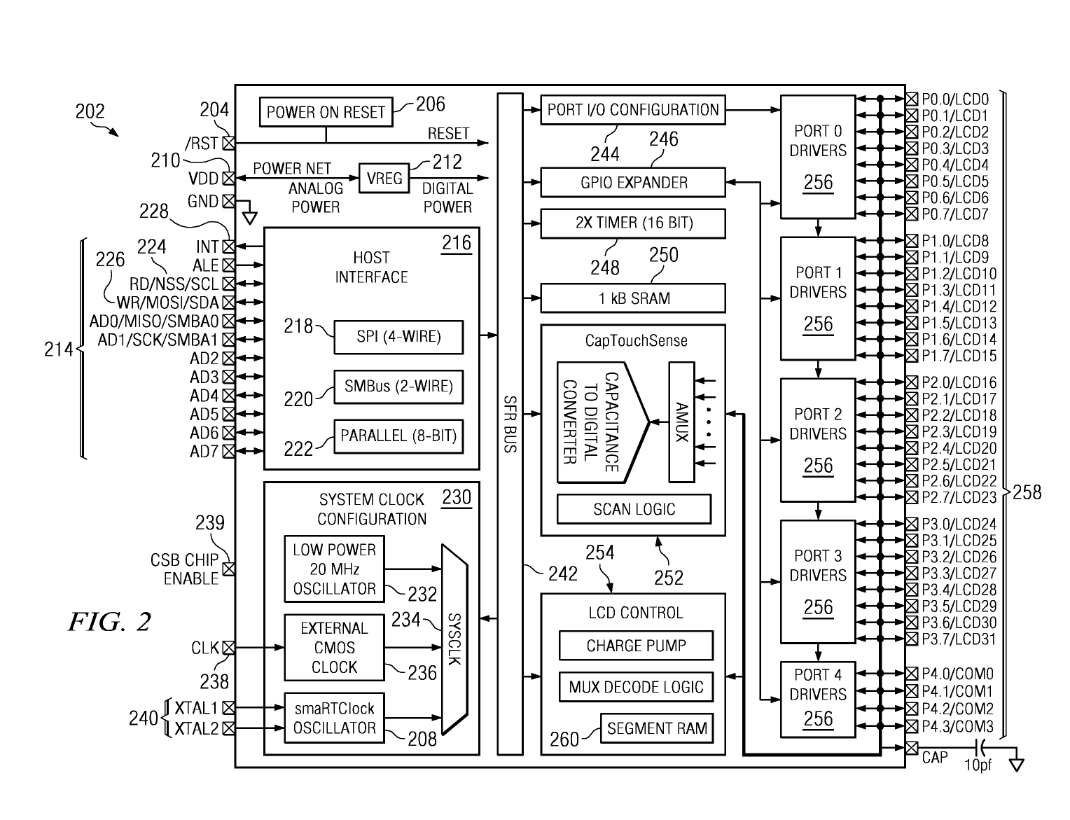

Referring now to FIG. 2, there is illustrated a block diagram of the LCD controller 202. The LCD controller 202 has two main reset sources. These include the RST PIN 204 and the power on reset block 206. The power on reset signal is generated by the power on reset block 206 when the LDO (low dropout regulator) 212 turns on. In low power mode, when the LDO 212 is enabled, a power on reset signal is generated which will reset all of the logic except for the real time clock 208 and the LCD power control block (not shown). These blocks can only be reset via the RST PIN 204 when the LCD low power enable bit is turned off. After this, the real time clock 208 can be reset via either source, although the LCD low power block can still only be reset via the RST PIN 204. System power is provided via a V_{DD} pin 210 to a voltage regulator block 212. The system power applied to V_{DD} pin 210 is used to provide external power to the system through an associated power net and the voltage regulator 212 provides regulated voltage to provide regulated power throughout the LCD controller 202. The power at V_{DD} pin 210 is the raw unregulated power that is used to power the analog circuitry and provide power in low power mode. Basically, this is considered to be V_{BAT} for the battery voltage. It is basically just the external voltage. Note that the regulated power can be disabled in low power mode.

The LCD controller 202 is a slave to an external MCU through a plurality of interface pins 214 connected with the host interface functions 216. The host interface 216 supports a four wire SPI interface 218, a two wire SMBus interface 220 and an eight bit parallel EMIF interface 222, all in a slave mode of operation only. The EMIF interface is described in U.S. patent application Ser. No. 10/880,921, filed Jun. 30, 2004, publication No. 2006/0002210, entitled “ETHERNET CONTROLLER WITH EXCESS ON-BOARD FLASH FOR MICROCONTROLLERS,” which is incorporated herein by reference in its entirety. The EMIF interface 222 only supports multiplexed access and intel mode. The bus type supported by the host interface 216 is selected via the RST pin 204. A default mode for the LCD controller 202 is the SPI mode, providing for a serial data communication mode of operation. When the LCD controller 202 is held in reset via the RST pin 204 while the RD (read) pin 224 and the WR (write) pin 226 are each held high, the LCD controller 202 will power up in the EMIF mode controlled by the parallel eight bit interface 222. If, while the part is in reset, the RD pin 224 is held high or low while the WR pin 226 is held low, the controller 202 will power up in the SPI mode controlled by SPI interface 218. Finally, if while the LCD controller 202 is held in reset, the WR pin 226 is held high while the RD pin 224 is held low, the controller 202 will power up in the SMbus mode controlled by the SMBus interface 220.

The INT pin 228 is used to indicate the interface mode upon leaving reset mode. Upon exiting the reset mode, the INT (interrupt) pin 228 will be toggled with a frequency of the system clock divided by 2 to indicate that the EMIF bus has been selected. The INT pin 228 will toggle with the frequency of the system clock divided by 8 to indicate that the SPI mode has been selected, and the interrupt pin 228 will be toggled with the frequency of the system clock divided by 32 to indicate the SMBus mode selection. This toggling will go on for 256 system clock cycles after which the INT pin 228 will revert to functioning as the interrupt pin.

As noted herein above, each of the LCD controllers 202 is addressable. When the EMIF interface is utilized, i.e., a parallel address and parallel data is input to the system through this interface, the chip enable pin 239 is utilized, this being the CSB pin. Thus, there will be provided a separate line for each LCD controller 202 from the MCU 104. By enabling the particular chip, the data and address information can be sent thereto such that data can be written to a specifically addressed SFR or read therefrom. As noted herein above, each LCD controller 202 is substantially identical such that the address space for each SFR is the same for each LCD controller 202. As such, there must be some way to distinguish between the two parts. With respect to the serial data bus protocols, the chip enable pin is not required, as each of these two protocols has the ability to address a specific chip. Again, this is part of the protocol. Thus, all that is required to address a particular chip and write data thereto or read data therefrom is a communication path and a particular data communication protocol and an appropriate way to select a particular chip. Further, each of these chips will have a separate interrupt pin that will allow an interrupt to be sent back to the MCU 104. There will, of course, have to be provided one interrupt line for each LCD controller 202 such that the particular LCD controller can be distinguished. What will happen then is that the MCU 104 will take the appropriate action which will typically require the chip to be enabled and, after enabling, download the appropriate configuration information thereto, this assuming that the LCD controller 202 which generated the interrupt were in the low power mode of operation.

The system clock configuration block 230 enables the provision of a system clock signal from up to six clock sources. The low power 20 MHz oscillator 232 may provide a 20 MHz clock signal or alternatively may be divided by 2, 4 or 8 to provide a divided down 20 MHz clock signal to a multiplexer 234 for selection as the system clock. Additionally, external CMOS clock circuitry 236 may be used to provide the clock signal to the multiplexer 234 responsive to an external clock received via a clock pin 238. Finally, a real time clock oscillator 208 may be used to provide a system clock signal to the multiplexer 234. The real time clock is configured via a pair of external pins 240.

The LCD controller 202 boots up running the 20 MHz oscillator 232 in a divide by 4 mode. The LCD controller 202 may then be configured to any of the other clock sources. The internal oscillator can be controlled, i.e., turned on and off, either using an internal control register while running off the CMOS clock or by using an external control mode while toggling a pin (in this case the CMOS_clock pin 238) to turn the internal oscillator on and off. The system clock configuration block 230 and associated clock circuitry therein are described in co pending U.S. application Ser. No. 11/967,389 entitled “Power Supply Voltage Monitor” which is incorporated herein by reference. The system clock configuration 230 with the control register includes a control register bit which may be used to enable a sleep mode of the system clock. When this register bit is set, the clock pin 238 may be used to enable and disable the internal low power oscillator 232 without removing power from the remainder of the controller circuitry. This would comprise a sleep mode wherein the circuitry of the controller 202 remains under system power, i.e., connected to V_{BAT} or V_{EXT} on V_{DD} pin, but no clock signal is provided from the oscillator 232. The real time clock oscillator 208 is unable to be trimmed. The real time clock oscillator 208 requires a 32 KHz oscillator and runs on the V_{BAT} voltage domain, external power. The RTC 208 provides the LCD clock source for the LCD controller 202 both in high and low power modes since it is powered from external power and will not lose power when the LDO 212 is powered down. The RTC clock 208 may be reset by the RST pin 204 only when in low power operation. When in high power mode, the RTC clock 208 might be reset by either the reset pin 204 or the power on reset 206.

The chip enable pin 239 enables the controller 202 to be operated in two different modes. The chip enable pin 239 may be used as a chip select bit and, when in the EMIF communication mode with the external master controller. In a second mode of operation, when a particular bit within an associated SFR register is set, the chip select bit 239 may be used to enable and disable the voltage regulator 212 within the controller 202 without removing power to the rest of the circuitry running on V_{BAT} within the controller 202. In this mode of operation, a bit is set internally that will designate the chip select bit as being an enable/disable pin for the LDO. In this mode of operation, the MCU 104 can generate through a dedicated line to a particular LCD controller 202 a signal that will cause the system to go into a low power mode. In this mode, what will happen is that the LDO will be powered down. This will result in the loss of power to a large block of circuitry, including registers and such. However, there will be a certain portion of the circuitry, such as certain portions of the LCD drivers or capacitive scanning circuitry that will be enabled. The RTC clock will also remain powered, since it is not driven from the output of the LDO 212. In this mode of operation, there will be certain registers that draw little power, but can be powered from the external power which is not regulated and may vary quite a bit. This particular circuitry, of course, is fabricated from high voltage circuitry whereas the circuitry associated with the output of the LDO 212 can have a regulated voltage and can be fabricated from much lower power (lower voltage) circuitry with thinner oxides and the such. When the system is re-enabled, what will happen is the LDO will be powered up and then a power on reset generated. In this power on reset, what will happen is that certain registers will be cleared, as they may have an unknown state, and then the configuration information is downloaded from the MCU 104 over the communication bus 110 to the LCD controller 202. The reason that this is required is because no flash memory is contained on-chip to the LCD controller 202. If memory were provided, this would not be necessary. However, that results in a much more expensive part and a different fabrication process. Since the MCU 104 has flash memory, it is only necessary to download the information thereto. As noted herein above, one event that can cause the MCU 104 to re-enable the part is the generation of an interrupt by the part. This interrupt indicates the presence of a touch on the capacitive sense array or the change of a value on a GPIO pin or any other pin with the port match feature. The re-enable is necessary in order to service the interrupt. However, during operation where the system is waiting for some change in the capacitive sense array or waiting for some change in data on a port, the part is placed in a low power mode of operation.

Components within the LCD controller 202 communicate via an SFR bus 242. The SFR bus 242 enables connections with a number of components including port I/O configuration circuitry 244, GPIO expander 246, timers 248, SRAM 250, capacitive touch sense circuitry 252 and the LCD control block 254. The port I/O configuration circuit 244 enables control of the port drivers 256 controlling a plurality of general purpose input/output (GPIO) pins 258 to configure the ports as digital I/O ports or analog ports. These GPIO pins 258 may be connected with a liquid crystal display controlled via the LCD control block 254, or alternatively, could be connected with a capacitive sensing array controlled via the cap touch sense circuitry 252. Further, they could be configured to be a digital input or output to allow the MCU 104 to expand its own internal GPIO capabilities.

The GPIO expander 246 offers a connection to 36 GPIO pins 258 for general purpose usage. The GPIO expander 246 allows the MCU 104, which itself has a plurality of pins which can be dedicated to digital input/output functions, to expand the number of pins available thereto. By addressing a particular LCD controller 202 and downloading information thereto while that LCD controller 202 is configured as a GPIO expander, data can be written to or read from any set of the GPIO pins on that LCD controller 202. This basically connects those pins through the port drivers to the SFR bus of the MCU 104.

The GPIO pins 258 can also be used for port match purposes. In the port match mode, each port can be treated as a match target with individual match selects for each pin. The port match process is a process wherein an internal register has a bit associated with a particular input/output pad. This pad will have associated therewith a digital I/O circuit which allows data to be received from an external pin or transmitted to an external pin. When configured as a digital I/O pin, this feature is enabled. However, each pin can also be configured to receive analog data or transmit analog data such that it is an analog pin. When so configured, the digital I/O circuitry is disabled or “tri-stated.” The port match feature has digital comparator circuitry external to the pad provided which basically compares the current state of the associated pin with a known bit, this being a bit that is on the pin of the time of setting. When the data changes, this will indicate a change in the state which will generate an interrupt and will load information in a particular register such that this internal register or SFR can be downloaded and scanned to determine which port incurred a change. Of course, the MCU 104 also can just read the port pin itself. What this allows is one pin to be “toggled” to allow a signal to be sent external to the chip (LCD controller 202) to the MCU 104 indicating that new data has arrived. This is a way of clocking data through.

If an ultra low power port match mechanism is desired, the LCD controller 202 can be switched into ultra low power mode and the same register used for the ultra low power mode LCD data can be utilized to save match values. In this mode, the port match is forced to either match on all negative going signals or all positive going signals based on a bit in a configuration register. A port match will cause the generation of an interrupt via interrupt pin 228 which will cause the master controller MCU 104 to have to turn on the LDO 212 by pulling the CS pin low and, after detecting an interrupt, begin communicating with the LCD controller 202.

The timers 248 comprise generic 16 bit timers. Upon overflowing, the timers 248 will generate an interrupt via interrupt pin 228 to the master controller. The timer circuit 248 comprises two 16 bit general purpose timers. One timer is normally used for the SMBus time-out detection within the controller 202. The other timer is used as the capacitive sense time-out timer for the capacitive touch sense circuitry 252. The 1 kB SRAM 250 is offered for general purpose usage and can be read from and written to via any of the three host interfaces 216. The RAM 250 can be unpowered if desired via a configuration bit. Thus in applications that do not require extra SRAM, power can be saved by powering down the RAM. Note that this RAM 250 will lose its contents when the LDO is shut off.

The cap touch circuitry 252 implements a capacitive touch capability up to a maximum of 128 possible sensing locations. This large number of touch sense pins is supported via an array sensing capability. The cap touch sense circuitry 252 includes three operating modes, the linear auto scan mode, the row/column auto scan mode and the 4×4 scan with LCD mode. Each capacitive pin detection takes approximately 32 microseconds. Thus, sensing 128 possible touch sense locations will take approximately 4.6 milliseconds which is well within any human interface appliance timing requirements. As noted herein above, whenever the system is configured for scanning, the system can operate in a low power mode or in a high power mode. In a low power mode, the system basically waits for some indication that a particular pad has been touched and then generate an interrupt. As will be described herein below, this basically utilizes the analog aspect of each of the pads, i.e., the analog value on each of the pads is sensed.

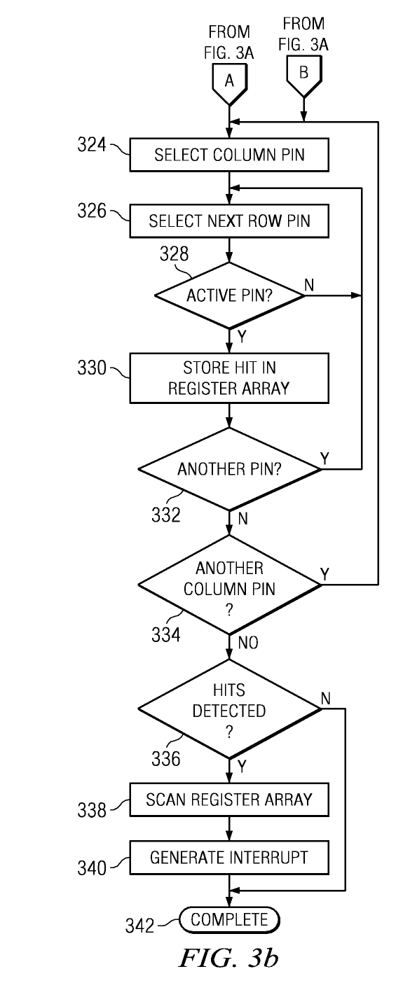

Referring now to FIG. 3a through 3b, there is illustrated a flow diagram describing the operation of the various modes of the capacitive sense touch circuitry 252. The various scan modes can be initiated either via a timer overflow, a user generated “start signal,” or an auto start mode wherein, upon completion of every pin conversion, the logic will switch to the next pin and begin another conversion. Once this initiation has been determined to be received at inquiry step 302, inquiry step 304 determines the particular mode of operation of the capacitive touch sense functionality 252. The capacitive touch sense circuitry 252 may operate in the linear auto scan mode 306, the row/column auto scan mode 308 or the row/column with LCD mode 310.

The linear auto scan mode 306 scans pins between a specified start point and end point continuously. Every time an end point is hit, an interrupt is generated if any of the pins detected a touch. Otherwise, the process begins scanning from the start pin again. In the row/column auto scan mode 308, rows and columns are scanned via a touch sense array structure. Up to 4 pins are reserved as “column pins” and any number up to a maximum of 32 pins can be reserved as “row pins.” Each of the 32 rows is cycled through once for each column, thus generating a maximum of 32×4 possible hits. The row/column results are stored in an 8×16 register array with one bit representing each pin. At the end of the entire row/column scan an interrupt is generated only if a hit was detected, at which time the master controller can scan the row/column register array and determine which pins where actuated. In the row/column with LCD mode 310, four pins are reserved as column pins and up to a maximum of 4 pins can be treated as row pins giving a maximum of 16 possible touch sense points. The remaining pins are used to drive an LCD. This mode operates similar to the row/column mode except for the limitations on the number of pins dedicated to the cap sense functionality.

If the linear auto scan mode is selected, the mode is initiated at step 306 and the start pin to be scanned is determined at step 312. The determined start pin is scanned at step 314 and inquiry step 316 determines if this is the final pin according to the linear scan mode. If not, control passes to step 317 to move to a next pin, and the next pin is scanned at step 314. This process continues until the end pin is reached at inquiry step 316, and inquiry step 318 determines if one of the sense pins has been activated. If not, control passes back to step 312. The start pin is determined and scanning from the start pin to the end pin is again initiated. If one of the sense pins has been activated, an interrupt is generated at step 320. The process is completed at step 322 or control may pass back to step 312 to begin scanning at the start pin once again.

If inquiry step 304 determines that the device is in the row/column auto scan mode 308, a column pin is initially selected at step 324. A row pin associated with the column is selected at step 326. Inquiry step 328 determines whether the selected row pin is active or not. If not, control passes back to step 326 to select a next row pin. If the selected pin is active, control passes to step 350 wherein an indication of the hit related to the active pin is stored within the associated register array. Inquiry step 332 determines whether there is another pin within the row group of pins and if so, control passes back to step 326. If no further row pins exist, inquiry step 334 determines whether another column pin exists. If so, control passes to step 324 to select the column pin and scanning of each of the row pins within the column is carried out as described previously. If no additional column pins exist, control passes to step 336 wherein a determination is made if any hits were detected by the row/column scan process. If not, the process is completed at step 342. If hits were detected, the register array is scanned at step 338 to determine all of the pins having associated hits and an interrupt is generated at step 340 to reflect the appropriate pins that were activated.

If inquiry step 304 determines that the capacitive touch sense functionality 252 is in the row/column with LCD mode 310, the procedure for processing these capacitive touch sense pins is the same as that described with respect to the row/column auto scan mode. The only difference is that each of the 4 columns are limited to 4 rows such that each group includes a 4×4 matrix.

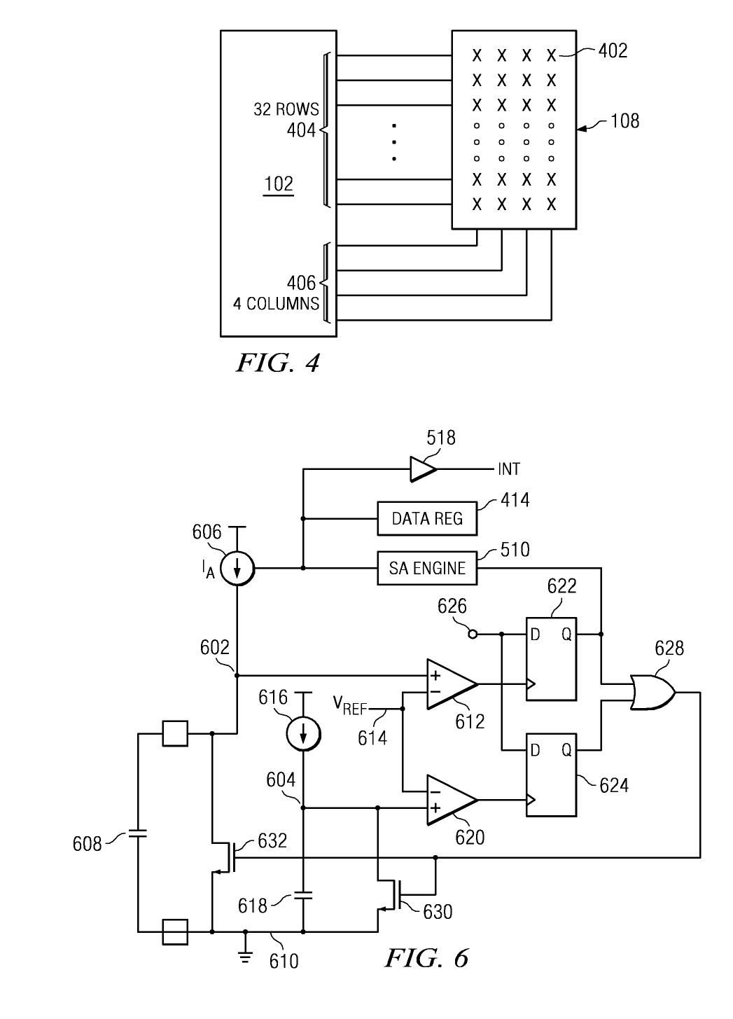

Referring now to FIG. 4, there is illustrated the manner in which the LCD controller 102 interconnects with a capacitor array 108 through the capacitive touch sense circuitry 252. The capacitor array 108 can consist of up to a 32 row by 4 column array of capacitive switches 402 each represented in FIG. 4 by an X. The capacitive switches 402 each have a connection to one of the 32 row pins 404 and to one of the four column pins 406. Thus, each of the capacitive switches 402 are connected with the LCD controller 102 at the intersection of the row connection 404 and the column connection 406. The capacitive touch sense circuitry 252 interconnects with the row and column pins connected to the capacitor array 108 and generates an interrupt each time it is sensed that at least one of the capacitive switches 402 within the capacitor sensor array 108 has been touched.

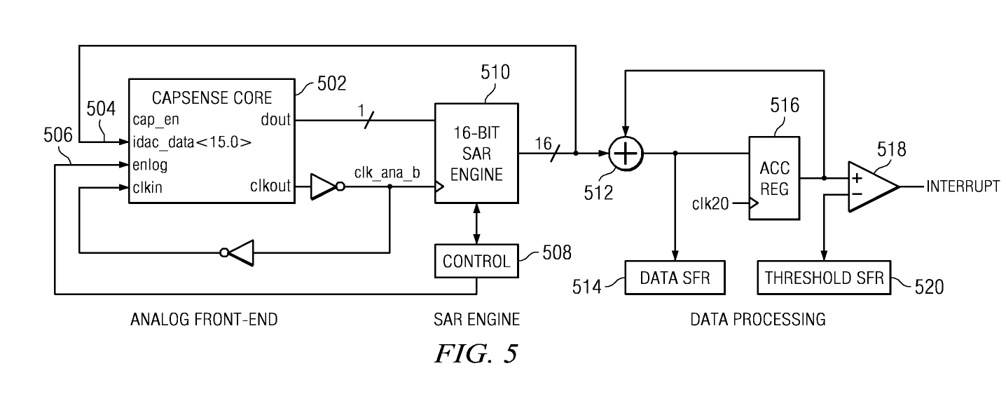

Referring now to FIG. 5, there is illustrated a functional block diagram of the capacitive touch sense circuitry 252. The analog front end circuitry 502 is responsible for detecting when a connected capacitive switch has been touched responsive to a comparison between currents generated at a reference node and a node associated with the capacitive switch as will be more fully described with respect to FIG. 6. The analog front end circuitry 502 receives a 16 bit current control value which is provided to the input IDAC_DATA via input 504 for controlling a variable current source. The analog front end also receives an enable signal at the input ENLOG 506 from a control circuit 508. The analog front end circuitry 502 additionally provides a clock signal. A 16 bit successive approximation register engine 510 controls a variable current source within the analog front end circuitry 502. The 16 bit SAR engine 510 changes a control value provided to the variable current source until the variable current source is equal to a provided reference current source responsive to control signals from control logic 508.

The current source control value is also provided to an adder block 512. The control value establishing the necessary control current for the current source is stored within a data SFR register 514. An input may then be provided to an accumulation register 516 providing an indication that a touch has been sensed on the presently monitored capacitive switch of the capacitor sensor array. Multiple accumulations are used to confirm a touch of the switch. The output of the accumulation register 516 is applied to the positive input of a comparator 518 which compares the provided value with a value from a threshold SFR register 520. When a selected number of repeated detections of activations of the associated capacitive switch within the capacitor sensor array have been detected, the comparator 518 generates an interrupt to the master controller connected with the LCD controller. The output of the accumulation register 516 is also provided to the adder circuit 512.

Referring further to FIG. 6, there is more particularly illustrated the analog front end circuitry 502 and associated components of the capacitive touch sense circuitry 252 described previously with respect to FIG. 5. The capacitive touch sense circuitry 252 illustrated in FIG. 6 compares the voltage at node 602 with the voltage at node 604. The voltage at node 602 is controlled by the variable current source 606 whose current value is controlled by a 16 bit input from the successive approximation engine 510. The voltage at node 602 is also controlled by an effective capacitance 608 created between node 602 and the ground node 610. The capacitance 608 is caused by the placement of a finger upon one of the capacitive switches 402 described previously with respect to FIG. 4. The voltage at node 602 is provided to the positive input of a comparator 612. The negative input of the comparator 612 is connected to a reference voltage provided at node 614. A known current source 616 is input to node 604 for charging a capacitor 618 connected between node 604 and ground to control the voltage at node 604. Node 604 is connected to the positive input of a comparator 620 which compares the voltage at node 604 with the reference voltage V_{REF} at node 614.

The output of the comparator 612 is provided as a clock input to a flip-flop circuit 622. The output of comparator 620 is provided as a clock input to flip-flop 624. Connected to the D-inputs of each of flip-flops 622 and 624 is a data input from node 626. The data input at node 626 represents a tie to the supply. The outputs of flip-flops 622 and 624 are connected to the inputs of an OR gate 628. The output of flip-flop 622 is additionally provided to the successive approximation engine 510. The OR gate 628 generates an output on each conversion cycle to turn on transistors 630 and 632 to discharge the voltage on each of capacitors 608 and 618. Transistor 630 has its drain/source path connected between node 604 and ground. Its gate is connected to the output of the OR gate 628. The drain/source path of transistor 632 is connected between node 602 and ground. The gate of transistor 632 is also connected to the output of the OR gate 628. When the comparator 612 indicates that an activation of an associated capacitive switch 402 has been detected, the value presently provided from the successive approximation register engines 510 controlling the variable current source 606 is stored within the data register 414. An interrupt is also generated from the comparator 518 as described previously with respect to FIG. 5 to indicate to the master controller that a switch activation has been detected.

Thus, the circuitry of FIG. 6 determines a control value provided by the successive approximation engine 510 in order to control the variable current source 606 to provide a voltage at node 602 that is equal to the voltage at node 604 controlled by reference current source 616. At each clock cycle, a comparison is made of the voltages at node 602 and 604. If these voltage values are not equal, the OR gate 628 will turn on transistors 630 and 632 to discharge the voltages at nodes 602 and 604. The SA engine 510 will then provide a new control value to the variable current source 606 to generate a new voltage at 602 and a new comparison between the voltages at nodes 602 and 604 may be made. Once the voltage values at node 602 and 604 are equal, the control value provided by the SA engine 510 to achieve this result is stored within the data register 414 and an interrupt is generated to the master controller.

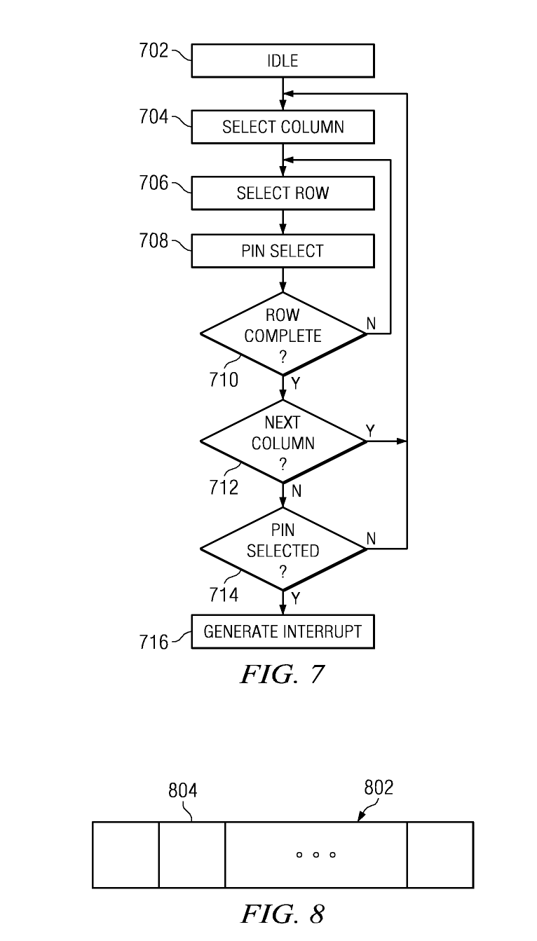

Referring now to FIG. 7, there is illustrated a flow diagram describing an operation of the state control engine 508 that controls the operation of the successive approximation engine 510 for monitoring the associated capacitive sensor array capacitive switches 502 to determine whether a particular capacitive sense switch has been activated. Initially, the system will be in the idle state 702. Once a scan process in one of the linear mode, row/column autoscan mode or row/column with LCD mode is implemented, an initial column is selected at step 704. Next, at step 706, a row within the selected column is selected and a determination is made if a pin having the selected row and column is being activated at step 708. Inquiry step 710 determines if each row for the selected column has been selected.

If not, control passes back to step 706 and a next row is selected for a further pin activation determination at step 708. If all rows have been selected for the column, inquiry step 712 determines if all columns have been selected. If a further column exists, control passes back to step 704 for selection of a next column. If no further columns exist to be selected, inquiry step 714 determines if any pins have been determined to have been activated by the process implemented by the state control circuit 508. If no, control may pass back to step 704 to again search through the capacitive switches for a pin activation. If inquiry step 714 determines that a pin has been selected, an interrupt may be generated at step 716 to the master controller to indicate the pin selection.

Detection of a pin selection at step 708 may be indicated within an SFR register within the capacitive touch sense circuitry 252 such as that indicated in FIG. 8. The SFR register comprises a 128 bit register with each bit associated with a capacitive switch within a 32 by 4 capacitive sensor array. When a particular capacitive switch is determined to be selected, the bit associated with this switch within the SFR register 802 may be set to a logical high value to indicate the bit selection. Once the interrupt has been received by the master controller, the master controller accesses the switch selection SFR register 802 to read the contents of the register to determine which capacitive switches have been activated.

Referring now back to FIG. 2, the LCD control block 254 of the LCD controller 202 can operate in static, 2×, 3× or 4× multiplexed modes. The LCD control block 254 can drive a maximum of 128 LCD segments in 4× multiplex mode or 96 segments in 3× multiplex mode and 64 segments in 2× multiplex mode. In static mode, the LCD control block 254 will drive 32 segments. The LCD control block 254 also supports a blinking mode where individual segments can be blinked on and off. The LCD also supports a contrast selection setting capability supporting 16 different contrast levels. The LCD message buffer definition is similar to that in the TI MSP430 series of parts. A maximum of 32 LCD segment pins and 4 common mode pins are defined.

The LCD control block 254 also supports an ultra low power (ULP) static mode capability wherein the controller 202 will keep an LCD display lit while driven off the V_{BAT} supply and not use the charge pump or low dropout regulator. This is done by driving the LCD pad outputs directly via toggling the set and reset pins on the pad level shifters based on the data in a 32 segment message buffer 260. In the ultra low power mode of operation, the LCD controller 202 may be operated in static LCD mode to keep an LCD perpetually lit with repeating data. The data to be displayed on the LCD is written to 4 data registers independent of the normal LCD data registers. The rest of the part is shut down leaving the RTC clock and LCD running entirely off the V_{BAT} supply. If it is deemed necessary to change the data in the LCD data registers, the CS pin will have to be pulled low which will enable the LDO 212 and generate a power on reset to the reset of the chip after which communication can begin with the master and the LCD controller 202. Note that the bus type selection is latched in the logic running off the V_{BAT} domain thus, when returning from the ULP mode it is not necessary to go through bus selection signaling again. The reset pin, if toggled at this time, will reset the LCD as well as the rest of the chip, thus requiring bus selection signaling once again. Note that since this mode toggles, the digital outputs of the pads in this mode could also be used to generate any sort of low speed digital wave form on any of the GPIO pins 258.

In operation, the multiplexers associated with the analog voltage multiplexer 908 and the output control signals are actually provided in the I/O pad. In the I/O pad, there is provided a multiplexer which has four inputs associated therewith and a single output connected to the pin when the pin is configured for the analog mode at that port. Each of the multiplexers associated with each of the pads has a control signal associated therewith. This control signal is comprised of four lines, one for selecting each of the voltages in the multiplexer. Therefore, there will be a common four-line bus that will route the four lines for the four voltages to each of the multiplexers for each of the pads. There will then be four control lines dedicated to each multiplexer such that, for 38 pins, there will be 38×4 control lines that will control the multiplexers such that each multiplexer is individually controllable. Therefore, the multiplexing operation is transferred to the pads as opposed to being in a central circuit.

In ULP port match mode the part can be shut down completely, except for the RTC and LCD_LP blocks, except that when a port match is detected the interrupt pin is toggled, thus waking up the host controller which can then resume communications with the LCD controller based upon the preserved bus type selection. Note that the port match function in the higher power mode allows skipping of these steps since the machine states will be preserved unlike the ULP port match function.

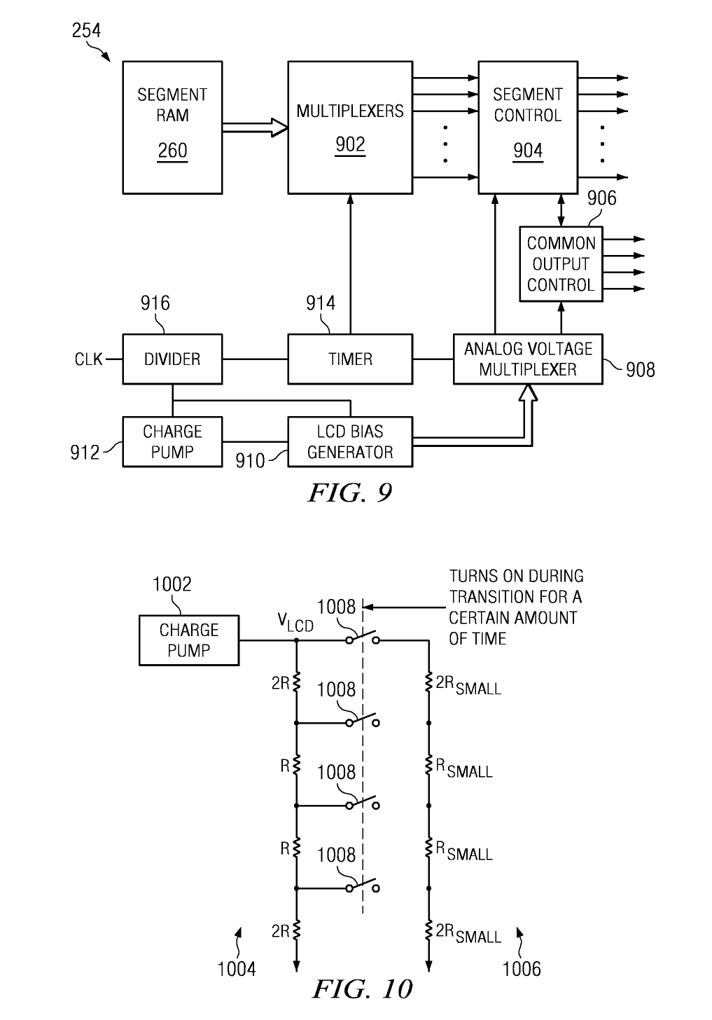

Referring now to FIG. 9, there is provided a functional block diagram of the LCD controller 254. The LCD controller 254 contains the components necessary for driving various segments of an attached liquid crystal display that is attached to the various I/O pins 258 (FIG. 2). Segment RAM 260 includes the information necessary for controlling the display of segments within attached liquid crystal displays to display information in a desired manner. The segment RAM 260 includes storage locations each associated with a particular LCD segment. In order to turn on an LCD segment, a memory bit within the segment RAM 260 is set.

The multiplexers 902 enable the LCD control block 202 to operate in either the static, 2×, 3×, or 4× multiplexed modes. The segment control block 904 provides the LCD controller with the ability to drive a maximum of 128 LCD segments in the 4× multiplexed mode, 96 LCD segments in the 3× multiplexed mode, and 64 LCD segments in the 2× multiplexed mode. Within the static mode, the segment control 904 may control 32 LCD segments. The common output control 906 provides four common mode pin outputs for providing control during 2×, 3× and 4× multiplexed modes.

The analog voltage multiplexer 908 provides the various voltages to the segment control block 904 and the common output control block 906 necessary for providing the voltages to activate or deactivate particular LCD segments. The bias voltages used by the analog voltage multiplexer 908 for driving the various crystal segments are generated within the LCD bias generator circuitry 910. A charge pump 912 provides the necessary voltages to the LCD bias generator 910 for generating the segment driving voltages. Timer circuitry 914 controls the timing of the LCD controller circuit 254. Finally, a divider circuit 916 may be used to generate various clock signals for controlling the operation of the timer circuitry 914 and the operation of the charge pump 912 and LCD bias generator 910 responsive to an externally provided clock.

Referring now to FIG. 10, when the charge pump 1002 is charging up a particular capacitor to a desired voltage, a pair of resistor ladders is used to speed up the capacitor charging process. A first branch of 1004 the resistor ladder includes larger values of resistors in a particular proportion. Connected to the larger branch is a second smaller resistance branch 1006 including the same numbers of resistors in the same relative proportion but including smaller value resistors. The first branch 1004 is connected with the second branch 1006 by a series of switches 1008. The first branch 1004 is used for adding on smaller voltage values to the capacitor being charged up by the charge pump circuitry 1002 and would be used in the later stages for fine tuning of the charge voltage value. The smaller resistance branch 1006 of the resistor ladder is used for providing a larger voltage to the capacitor being charged by the charge pump 1002. By closing the switches 1008 and switching the smaller resistance resistor ladder into the circuit, the charge pump 1002 will charge the associated capacitor in a much quicker fashion since a larger voltage may be provided through the smaller voltage resistance ladder. This is used for a coarse tuning of the voltage capacitor during initial charging. Once the initial larger amounts of voltage have been placed onto the capacitor in a faster manner, the smaller amounts of voltage may be added by the second branch 1004 to charge the capacitor to the desired value.

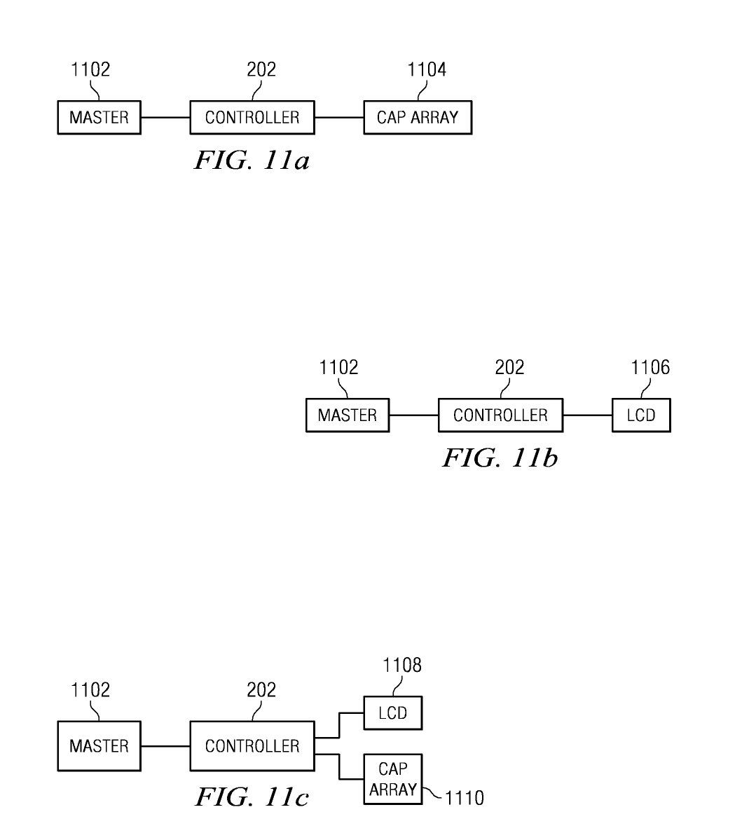

The LCD controller 202 provides a single integrated chip that may be slaved with a master controller and provides a number of different functionalities as shown in FIGS. 11a-11c. When an LCD controller 202 is slaved with a master controller 1102, the master controller 1102 may use the LCD controller 202 in a number of different configurations. In a first configuration (FIG. 11a), the controller 202 may solely utilize the capacitive touch sense circuitry 252 to sense capacitive switches upon an associated capacitive switch array 1004. The capacitive switch array 1104 may comprise up to 128 capacitive switches in 32 row and 4 column configuration. The capacitive switch array 1104 may also operate in any row and column configuration wherein the number of rows does not exceed 32 and the number of columns does not exceed four.

In a second mode of operation illustrated in FIG. 11b, the controller 202 is connected with a master controller 1102 and the controller 202 is used to drive LCD circuits 1106 using the LCD controller block 254 discussed herein above. In this configuration, the controller 202 is acting only as an LCD controller driver and no capacitive array sensing functionalities are provided.

In another mode of operation illustrated in FIG. 11c, the controller 202 under the control of a master controller 1102 may be used to control the operation of both liquid crystal displays 1108 and up to a 4×4 capacitive switch array 1110. In order for the controller 202 to provide this configuration, the controller 202 would be configured to operate in the row/column with LCD mode described previously with respect to FIG. 3. 24 pins of the controller 202 are used for driving segments of liquid crystal displays. The remaining 8 pins are used for providing monitoring of a 4×4 capacitive switch array. Thus, using the controller 202 in this configuration, an LCD display with a 16 button array may be utilized in combination with each other.

In addition to providing the combination of liquid crystal display driver and capacitive array sensor functionalities described herein above, the controller 202 may also be used in other manners by the master controller 1202. The GPIO expander circuit 246 may provide the master controller with access to an additional 32 general purpose I/O pins 258. The 1 kB of SRAM memory 250 is also not required by use of the controller 202 and may be used by the connected master controller 1202 to store information.

It will be appreciated by those skilled in the art and having the benefit of this disclosure that this LCD controller chip provides a flexible solution to provide both capacitive sensing capabilities for a capacitive sensor array and LCD driver controller capabilities on a single integrated chip. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. An integrated circuit, comprising:
a host interface control block for providing a connection between the integrated circuit and a master controller device;
a plurality of input/output pins;
capacitive touch sense circuitry enabling detection of actuation of at least one capacitive switch of a capacitive sensor array connected to at least a portion of the plurality of input/output pins;
an LCD controller for driving at least one LCD connected to at least a portion of the plurality of input/output pins; and
wherein responsive to control signals received from the master controller device over the host interface control block, the integrated circuit may be configured to monitor outputs from the capacitive sensor array in a first mode of operation, to drive the at least one LCD in a second mode of operation and to both monitor outputs of the capacitive sensor array and drive the at least one LCD in a third mode of operation.

2. The integrated circuit of claim 1, wherein the host interface control block comprises a plurality of interface communication protocols, each of the plurality of interface communications programmable selectable responsive to control signals from the master controller device.

3. The integrated circuit of claim 1, further including a GPIO Expander control block, wherein responsive to control signals received from the master controller device over the host interface control block, GPIO Expander configures the integrated circuit to operate as a GPIO Expander.

4. The integrated circuit of claim 1, further including a random access memory, wherein responsive to control signals received from the master controller device over the host interface control block, the random access memory may be used for storage by the master controller device.

5. The integrated circuit of claim 1, wherein in the first mode of operation the capacitive touch sense circuitry scans from a start pin to an end pin to detect actuations of the capacitive switches within the capacitive sensor array.

6. The integrated circuit of claim 1, wherein in the first mode of operation the capacitive touch sense circuitry scans each row of a selected column before proceeding to a next column.

7. The integrated circuit of claim 6, wherein the number of scanned rows and scanned columns are programmable responsive to control signals from the master control device.

8. An integrated circuit, comprising:
a host interface control block for providing a connection between the integrated circuit and a master controller device, wherein the host interface control block comprises a plurality of interface communication protocols, each of the plurality of interface communications programmable selectable responsive to control signals from the master controller device;
a plurality of input/output pins;
capacitive touch sense circuitry enabling detection of actuation of at least one capacitive switch of a capacitive sensor array connected to at least a portion of the plurality of input/output pins;
an LCD controller for driving at least one LCD connected to at least a portion of the plurality of input/output pins; and
wherein responsive to control signals received from the master controller device over the host interface control block, the integrated circuit may be configured to monitor outputs from the capacitive sensor array in a first mode of operation, to drive the at least one LCD in a second mode of operation and to both monitor outputs of the capacitive sensor array and drive the at least one LCD in a third mode of operation; and
wherein in the first mode of operation the capacitive touch sense circuitry scans from a start pin to an end pin to detect actuations of the capacitive switches within the capacitive sensor array in a first configuration and scans each row of a selected column before proceeding to a next column in a second configuration.

9. The integrated circuit of claim 8, further including a GPIO Expander control block, wherein responsive to control signals received from the master controller device over the host interface control block, GPIO Expander configures the integrated circuit to operate as a GPIO Expander.

10. The integrated circuit of claim 8, further including a random access memory, wherein responsive to control signals received from the master controller device over the host interface control block, the random access memory may be used for storage by the master controller device.

11. The integrated circuit of claim 8, wherein the number of scanned rows and scanned columns are programmable responsive to control signals from the master control device.

12. A method for providing programmable combinations of capacitive switch functionalities and LCD driver control functionalities, comprising the steps of:
providing a connection between an integrated circuit and a master controller device;
detecting actuation of at least one capacitive switch of a capacitive sensor array connected to at least a portion of a plurality of input/output pins when the integrated circuit is configured in a first mode of operation;
driving at least one LCD connected to at least a portion of the plurality of input/output pins in a second mode of operation; and
simultaneously detecting actuation of at least one capacitive switch of the capacitive sensor array connected to at least a portion of a plurality of input/output pins and driving at least one LCD connected to at least the portion of the plurality of input/output pins.

13. The method of claim 12, wherein the step of providing further comprises the steps of programmably selecting one of a plurality of interface communication protocols responsive to control signals from the master controller device.

14. The method of claim 12, further including the step of operating the integrated circuit as a GPIO Expander responsive to control signals received from the master controller device.

15. The method of claim 12, further including the step of providing a random access memory for storage by the master controller device responsive to control signals received from the master controller device.

16. The method of claim 12, wherein the step of detecting further comprises the step of scanning from a start pin to an end pin to detect actuations of the capacitive switches within the capacitive sensor array.

17. The method of claim 12, wherein the step of detecting further comprises the step of scanning each row of a selected column before proceeding to a next column.

18. The method of claim 17, wherein the step of scanning further includes the step of programmably selecting the number of scanned rows and scanned columns responsive to control signals from the master control device.
